(19) United States
(12) Patent Application Publication
(10) Pub. No.: US 2022/0231711 A1
(43) Pub. Date: Jul. 21, 2022

(54) FREQUENCY-AGNOSTIC WIRELESS RADIO-FREQUENCY FRONT END

(71) Applicant: Photonic Systems, Inc., Billerica, MA (US)

(72) Inventor: Charles H. Cox, Carlisle, MA (US)

(73) Assignee: Photonic Systems, Inc., Billerica, MA (US)

(21) Appl. No.: 17/611,936

(22) PCT Filed: May 18, 2020
(86) PCT No.: PCT/US20/33490

§ 371 Date: Nov. 17, 2021

Related U.S. Application Data
(60) Provisional application No. 62/850,574, filed on May 21, 2019.
(60) Provisional application No. 62/850,502, filed on May 20, 2019.

(51) Int. Cl. H04B 1/00; H04L 5/14

(52) U.S. Cl. CPC H04B 1/0064; H04L 5/1461

(57) ABSTRACT

A frequency-agnostic wireless radio-frequency front end includes a primary antenna that receives a desired receive signal and interference signals and transmits a desired transmit signal. A diversity antenna receives an internal interference signal and an external interference signal, and a desired receive signal. A receive front end has a first port electrically connected to the diversity antenna and a second port electrically connected to a transmit signal reference source and includes a cancelling circuit that removes the internal interference signal and the external interference signal and provides the desired receive signal to a third port. A transmit-and-receive front end generates the desired transmit signal and includes a connector that passes the desired transmit signal while simultaneously passing the desired receive signal and interference signals to a third port while at least partially blocking the desired transmit signal from propagating to the third port.

### CROSS REFERENCE TO RELATED APPLICATION

The present application is a non-provisional application of U.S. Provisional Patent Application No. 62/850,502, filed on May 20, 2019, entitled “Frequency-Agnostic Wireless Radio-Frequency Front End” and a non-provisional application of U.S. Provisional Patent Application No. 62/850,574, filed on May 21, 2019, entitled “Frequency-Agnostic Wireless Radio-Frequency Front End”. The entire contents of U.S. Provisional Patent Application Nos. 62/850,502 and 62/850,574 are herein incorporated by reference.

The section headings used herein are for organizational purposes only and should not to be construed as limiting the subject matter described in the present application in any way.

### INTRODUCTION

Widespread and increasing demand for wirelessly-connected systems has created a tremendous need for more efficient use and sharing of electromagnetic spectrum bandwidth. Compact, flexible and cost-effective wireless front ends are key subsystems for sharing that electromagnetic spectrum bandwidth. These wireless front ends should ideally support flexible and efficient transmit and receive operation using popular conventional wireless frequency bands. Such front ends need to support communications across numerous wireless systems, including cellular systems, WiFi and other Wireless LAN systems, satellite and various military RF communications systems.

More flexible RF front ends are needed to efficiently use the RF spectrum for cellular telephony and other applications. A specific example of the need for more flexible RF front ends is seen with the dominant spectral sharing method used in mobile cellular systems, Frequency Division Duplexing (FDD). In these systems, a different frequency is used for uplink and downlink communications between a cellular device of a mobile user and the cell tower base station. To support more user demand, access is needed to more frequency bands used for uplink and downlink connections.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates a schematic of a multi-antenna cell phone.

FIG. 2 illustrates a plot of the frequency bands for the International Mobile Telecommunications (IMT) as a function of year.

FIG. 3A illustrates the upper left quadrant of a schematic of example Long Term Evolution (LTE) Frequency Division Multiplexing (FDD) bands.

FIG. 3B illustrates the upper right quadrant of the schematic of example Long Term Evolution (LTE) Frequency Division Multiplexing (FDD) bands described in connection with FIG. 3A.

FIG. 3C illustrates the lower left quadrant of the schematic of example Long Term Evolution (LTE) Frequency Division Multiplexing (FDD) bands described in connection with FIG. 3A.

FIG. 3D illustrates the lower right quadrant of the schematic of example Long Term Evolution (LTE) Frequency Division Multiplexing (FDD) bands described in connection with FIG. 3A.

FIG. 4 illustrates a known RF system that includes a front end comprising multiple duplexers.

FIG. 5 illustrates an embodiment of an RF system that includes a frequency-agnostic front end according to the present teaching.

FIG. 6 illustrates an embodiment of an RF system that includes a frequency-agnostic front end and includes common amplifiers according to the present teaching.

FIG. 7A illustrates an embodiment of an RF system that includes a frequency-agnostic receive front end for a diversity antenna according to the present teaching.

FIG. 7B illustrates an embodiment of an RF system that includes a frequency-agnostic transmit and receive front end for a primary antenna according to the present teaching.

FIG. 8 illustrates an embodiment of a frequency-agnostic interference reducer processor according to the present teaching.

FIG. 9 illustrates an embodiment of an RF antenna system comprising a frequency-agnostic transmit and receive front end that utilizes travelling wave structures to form a connector according to the present teaching.

FIG. 10 illustrates an embodiment of an antenna system comprising a frequency-agnostic transmit and receive front end that utilizes subtraction according to the present teaching.

FIG. 11 illustrates another embodiment of an antenna system comprising a frequency-agnostic receive front end that utilizes a subtractor according to the present teaching.

FIG. 12 illustrates an embodiment of an antenna system comprising a frequency-agnostic transmit and receive front end that utilizes a fast switch according to the present teaching.

FIG. 13 illustrates an embodiment of an antenna system with a frequency-agnostic receive front end that utilizes a fast switch according to the present teaching.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the apparatus and methods of the present teachings can include any number or all of the described embodiments as long as the teaching remains operable.

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Marconi's original “wireless”, circa 1894, used a spark-gap transmitter, which produced a waveform that covered a wide, poorly-defined, portion of the RF spectrum. Since Marconi was the only one broadcasting, there was no issue of interference with other users. However, with the rapid increase in both the popularity of wireless and the sophistication of the technology to support it in the early 1900s, interference among wireless users quickly became an issue. The first solution to manage interference was via regulation that was first formally implemented in the Radio Act of 1912. Then the Federal Radio Commission was established in 1926, which became the Federal Communications Commission (FCC) in 1934. The FCC established regulations that defined user frequency bands and regulated transmit powers levels for those bands as well as the residual power levels that were allowed to spill over into adjacent bands.

The early regulations were essentially frequency-specific, but signal-agnostic, regulations. That is, any signal that was at an unwanted regulated frequency needed to be suppressed by the user regardless of its signal format. To meet these requirements, RF filters were developed throughout the remainder of the 20^{th} century using many different designs that were implemented using a myriad of technologies to filter out specific frequencies.

In the first two decades of the 21^{st} century, there has been an exponential expansion in the use of wireless technology with the major application of wireless technology being mobile, cellular phones. There are currently on the order of about 4.6 billion users of such devices, which is roughly two thirds of the world's population. The increased demand for RF spectrum, which is a fixed resource, has resulted in skyrocketing costs for RF spectrum. A recent U.S. Government spectrum auction sold RF spectrum for $3.3 billion dollars/MHz.

The increasing demand for, and cost of, RF spectrum has greatly increased the incentive for developing new technologies to more efficiently utilize existing RF spectrum. One approach to more efficiently utilize existing RF spectrum is to reduce the frequency separation between frequency bands. A finite separation between any two adjacent bands, called a guard band, is presently required because any realizable RF filter needs a minimum frequency band over which to transition between passing and blocking signals. For example, for cellular telephony, there is presently greater than 100 MHz of spectrum tied up in the guard bands between up- and down-link bands. However, using sharper filters that can more rapidly transition between passing and blocking is technically challenging and expensive. Thus, there are conflicting constraints of the economic necessity for narrower guard bands vs. the cost and complexity of deploying such sharper filters. A conventional filter-based approach is not likely to yield a practical solution that will result in more economical and efficient use of the RF spectrum.

One aspect of the present teaching is the realization that the interfering signals are not random, unknown signals. Rather, many of the characteristics of the interfering signals that need to be suppressed are actually known. The methods and apparatus of the present teaching use this known information about the characteristics of the interfering signals to suppress these signals. The suppression can occur regardless of the frequency of the interfering signals.

The methods and apparatus of the present teaching result in a signal-specific, frequency-agnostic method of suppressing signals. Using the methods of the present teaching, there is no need for conventional pass and stop bands, and hence no need for a transition or guard band between them. Therefore, the very valuable spectrum that is presently used for the guard bands can be freed up and made available to convey additional signals. The signal-specific suppression technique described herein is a technology-based solution to mitigating interference, in contrast to the current regulation-based solutions. The result of using these signal-specific suppression techniques is efficient and flexible sharing of wireless spectrum.

Some aspects of the present teaching are described more specifically in connection with cellular telephony. The dominant format used to share spectrum in mobile cellular phone systems is Frequency Division Duplexing (FDD), which uses one frequency band for the downlink from the base station to the mobile user and another frequency for the uplink from the user to the base station.

In modern cellular FDD telephony systems, these uplink and downlink frequencies are separated in an electronic front end that connects transmitters and receivers to wireless antennas in the base stations and in the mobile devices. In order to support efficient high-capacity communications, the frequency bands are narrow and tightly spaced so the front end device that separates and combines the uplink and downlink signals must have high frequency selectivity and must be capable of operating over a wide range of frequency bands.

However, the components used in these front end devices that allow them to perform well separating out signals in noisy RF cellular environments do not scale well as the number of bands increases and the spacing between bands decreases. Making suitable components is technically challenging as these devices need to operate with narrow, closely-spaced bands. Consequently, current state-of-the-art cellular devices are limited in the number of frequency bands they can accommodate.

More flexible RF front ends are needed to efficiently use the RF spectrum for cellular telephony and other applications. At the wireless front end, frequency duplexers convey the uplink and downlink transmit and receive signals using filters with fixed central frequencies and bandwidths, or frequency spans, to pass the desired signals. In general, a separate duplexer is used for each frequency band. As the number of frequency bands increases so does the required number of duplexers needed to support the many bands. Using a large number of duplexers significantly adds to the physical size and cost of the wireless front end. Because space is at a premium in mobile devices, this often means that the number of bands accessible by a particular device is restricted, greatly limiting the connectivity options for that device. As such, new approaches are needed for front ends that allow a single wireless device, such as a cellular device, to transmit and receive over an arbitrary number of frequency bands with performance that exceeds the performance of a device using prior art front end components.

One feature of the present teaching is the recognition that recently developed technologies that were designed to enable single-channel, full-time full duplex communications can be applied to enable a single wireless device, such as a cellular device, to transmit and receive over an arbitrary number of frequency bands with performance that exceeds the performance of a device using prior art front end components. The key insight to eliminating all the filtering components—duplexers and channel filters—is to appreciate that there are actually two sources of interference that need to be suppressed. One class of interference is self-interference. This type of interference is internally generated within a particular system; it arises from the leakage of a particular system's own high power transmit signal(s) into the sensitive receiver of the particular system. The second class of interference is externally generated; it arises from transmit signals of other systems that are co-located with a particular system entering the receive path of a particular system.

The reason it is important to distinguish these two classes of interference is that different methods are needed to remove each class of undesired interference signals from desired receive signals. For internally-generated interference, a reference copy of the transmit signal is available to assist in the cancellation, whereas for the externally-generated interference generally no reference copy is available. There are two categories of externally-generated interference signals. For the first category, the system can generate a reference copy of the externally-generated interference signal. For the second category, the system cannot generate a reference copy of the externally-generated signal. Thus, the first category of externally-generated interference signal can be treated in the same way as internally-generated interference signals. That is, if for some reason a reference copy of an externally-generated interference is available to a particular system, then suppression of such a signal can use the same methods as used for internally-generated interference.

One feature of the present teaching is that the cancellation architectures for interference signals for which reference copies are available are inherently broad bandwidth, thus supporting a wide range of frequency bands. Similarly, the cancellation architectures for interference signals for which reference copies are not available are inherently broad bandwidth and support a wide range of frequency bands. Both architectures support the separation of receive signals from transmit signals with high fidelity regardless of whether these signals are in the same or disjoint frequency bands, even when those transmit and receive signals are operating simultaneously. Both architectures also support the separation of receive signals from interfering signals with high fidelity regardless of whether these signals are in the same or disjoint frequency bands, even when those interfering and receive signals are operating simultaneously.

Many cell phones utilize multiple antennas. In various configurations, these multiple antennas can have various transmit and receive functions. For example, separate antennas can be used to transmit and receive in particular separate bands. Some antennas may transmit and receive and some antennas may receive only or transmit only. One challenge for cell phone design is mitigating interferences that arise amongst the various antennas. This is particularly true given the small footprint of the cell phone, which means antennas must be closely spaced leading to opportunities for high levels of interference both from transmitter to receiver, as well as reception of desired over-the-air signals as well as undesirable signals incident on the antennas.

Another feature of the frequency-agnostic wireless radio-frequency front end of the present teaching is that it mitigates interference between antennas, especially antennas that are co-located in a cell phone in very close proximity. Another feature of the present teaching is that it can reduce the number of components needed in a cell phone while still supporting a desired number of operating bands.

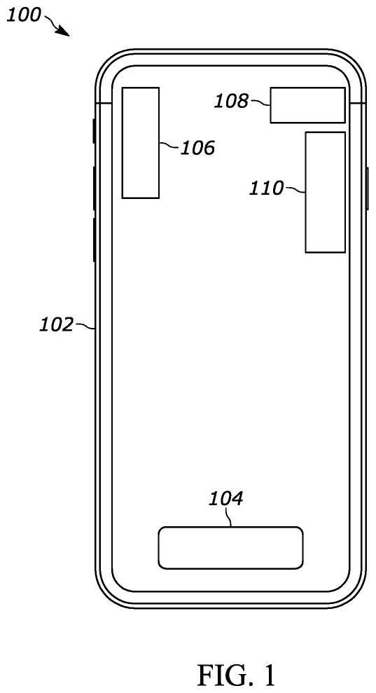

To provide specificity to the material to be presented below, we will use a mobile telephone system as a specific example. The present teaching is applicable to any number of known wireless systems. For cellular applications, the present teaching is applicable to both the cell phone as well as the base station end of a mobile cell phone system; we will focus our description on the mobile cell phone end. FIG. 1 illustrates a schematic of a multi-antenna cell phone 100. A cellular telephone case 102 that contains antenna elements 104, 106, 108, 110 is shown. The schematic in FIG. 1 shows a physical layout with the approximate relative positions of the antennas 104, 106, 108, 110 in the case 102. In some modern cell phone designs, the primary antenna is antenna 104 that is located on the bottom of the case 102. In various embodiments, the primary antenna 104 both transmits and receives on various cell phone bands. As is well known to those skilled in the art, the particular operating bands of a cellular phone can depend, for example, on the particular service provider providing the phone service, whether or not the phone is configured for international service, and/or the intended types of cellular service (3G, 4G, 5G, LTE, CDMA, GSM, UMTS, etc.) being offered for the particular phone 100. Different cellular phones will provide different service capabilities that are based in part on what cellular frequency bands are supported by the various antennas 104, 106, 108, 110, associated front end components and transmit and receive electronics.

In the configuration shown in FIG. 1, a diversity antenna 106 is located near the top of the case 102. A diversity antenna provides a sample of the various signals that are incident on the cell phone to the cell phone electronics. Typically, the diversity antenna operates in receive-only mode. The independent received signal generated at an output of the diversity antenna is used in a number of ways depending on the desired configuration. For example, this signal can be used as a separate receive signal. In this configuration, the signal from the diversity antenna is switched into the receiver and data recovery system to provide a primary receive signal if the diversity signal is stronger than the primary receive antenna's signal. The signal can also be summed with the primary receive antenna's signal.

In the configuration shown in FIG. 1, a Global Positioning System (GPS) antenna 108 is located near the top of the case across from the diversity antenna 106. Also, a WiFi antenna 110 is located across from the diversity antenna near the top of the case 102. The antenna configuration shown in FIG. 1 is, of course, just an example. It should be appreciated that numerous other configurations of various antennas are possible. However, it should be noted that the physical antenna configuration is restricted to a footprint of less than 10-20 cm on a side and therefore the antennas 104, 106, 108 are closely spaced. Typically, the diversity antenna 106 is positioned far enough away from the primary antenna 104 such that known diversity receiving techniques can be used to improve signal reception.

Improving the ability to separate and suppress signals within the front end electronics associated with the antennas allows for closer spacing of the various antennas while still supporting required reception and transmission performance. One challenge with managing the configuration of antennas and transmit receive functions on a small device such as a cell phone 100 is the incredible growth in the number of frequency bands that are desirable to be supported in a single device. In addition to the growth, there is also uncertainty in the number and size of the bands that should be included. One example of this significant and uncertain growth in the numbers and frequency allocations of frequency bands for cellular systems is seen in international cellular standards evolution.

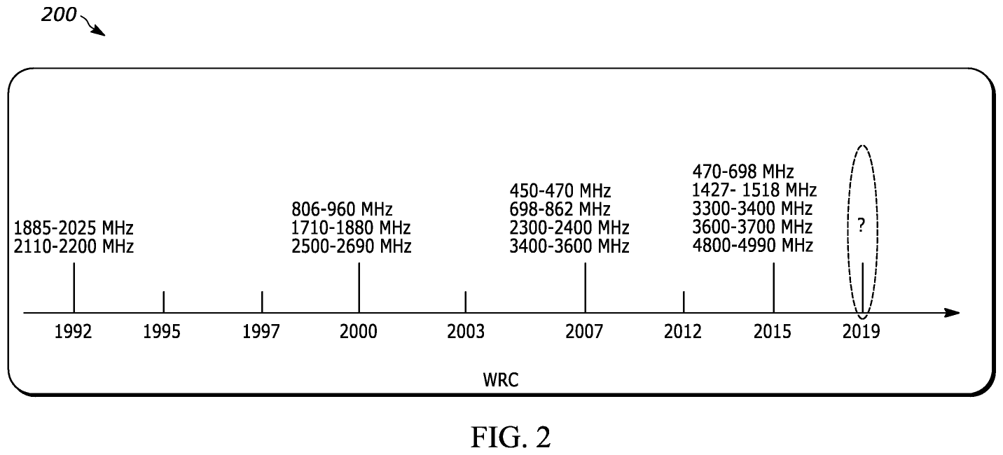

FIG. 2 illustrates a plot 200 of the frequency bands for the International Mobile Telecommunications (IMT) as a function of year. This plot 200 is taken from an International Telecommunication Union (ITU) presentation entitled “Spectrum Management for 4G-CTE”, www.itu.int. Clearly, the plot 200 shows very significant growth in the number of frequency bands used as a function of recent time. New bands added over 3-5 year time frames are allocated in both higher frequency bands and lower frequency bands as compared to the previous years. As of 2015, there was still a lack of clarity within the regulatory community as to exactly which bands and which frequency allocations would be utilized in 2019. This is illustrated by the question mark over the 2019 date.

It is highly desirable to provide a front-end system that can easily accommodate the increasing numbers of frequency bands. However, it is also important to be flexible enough to support frequencies that may be unknown at the time of design. That is, it is highly desirable to have a design that can accommodate a wide variety of frequencies, even any frequency, in the RF spectrum.

In FDD, to achieve bi-directional communication, a pair of channels is used, one for transmit and one for receive, that occupy disjoint parts of the electromagnetic spectrum. Thus, FDD up-link and down-link signals are communicated simultaneously using different frequency channels. FDD is widely used because it has a number of well-known practical advantages. Currently, approximately 80% of commercial wireless cellular communications systems use this form of duplexing. State-of-the-art cell phones are designed to support the known FDD pairs of uplink and downlink frequency bands. It is also desirable looking forward to be able to flexibly pair an uplink frequency band and a downlink frequency band, even if those two frequency bands are not contiguous or closely spaced in the spectrum. Thus, it is desirable that the front ends provide both wide bandwidth operation and the flexibility to select narrow operating bands anywhere within that wide bandwidth of operation.

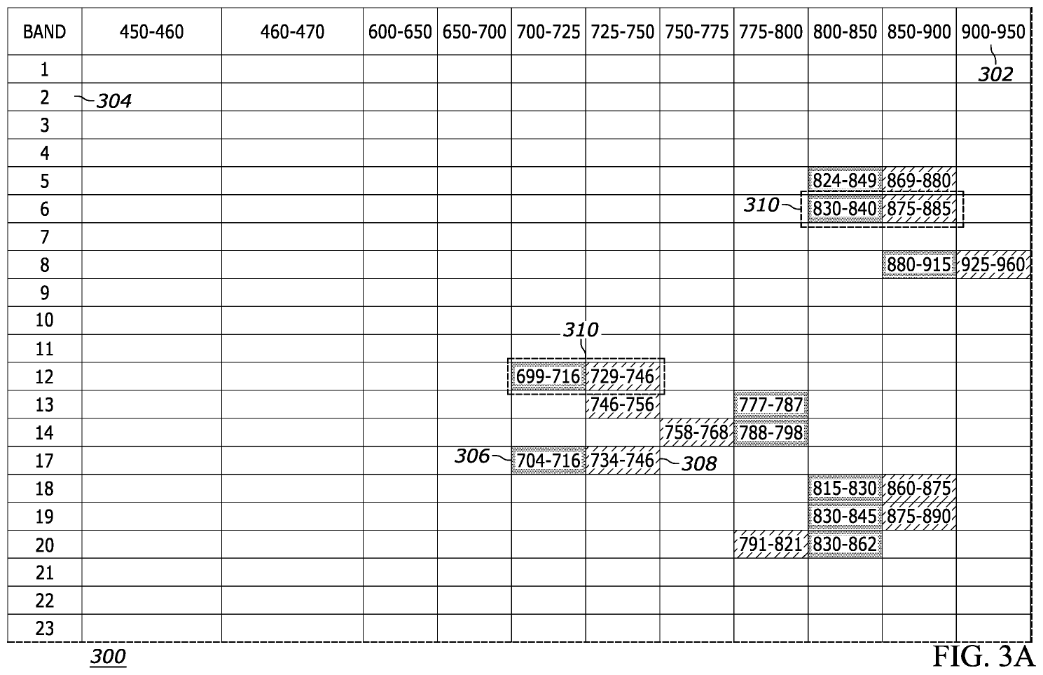

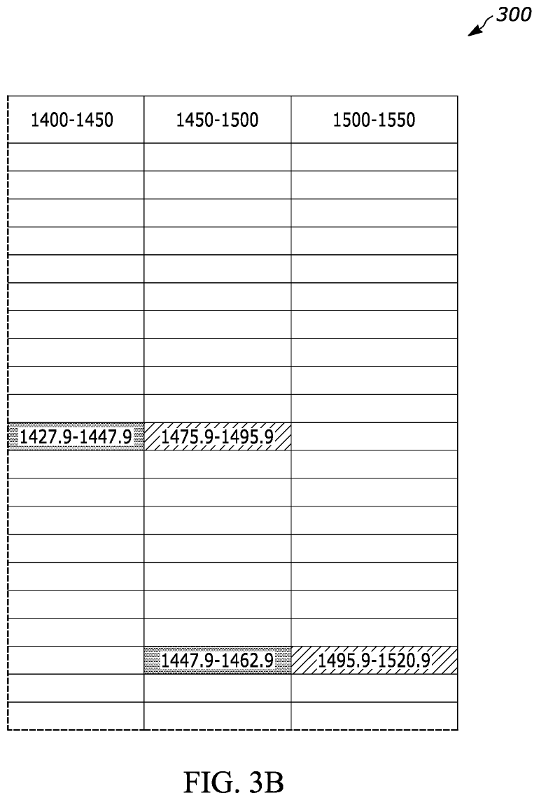

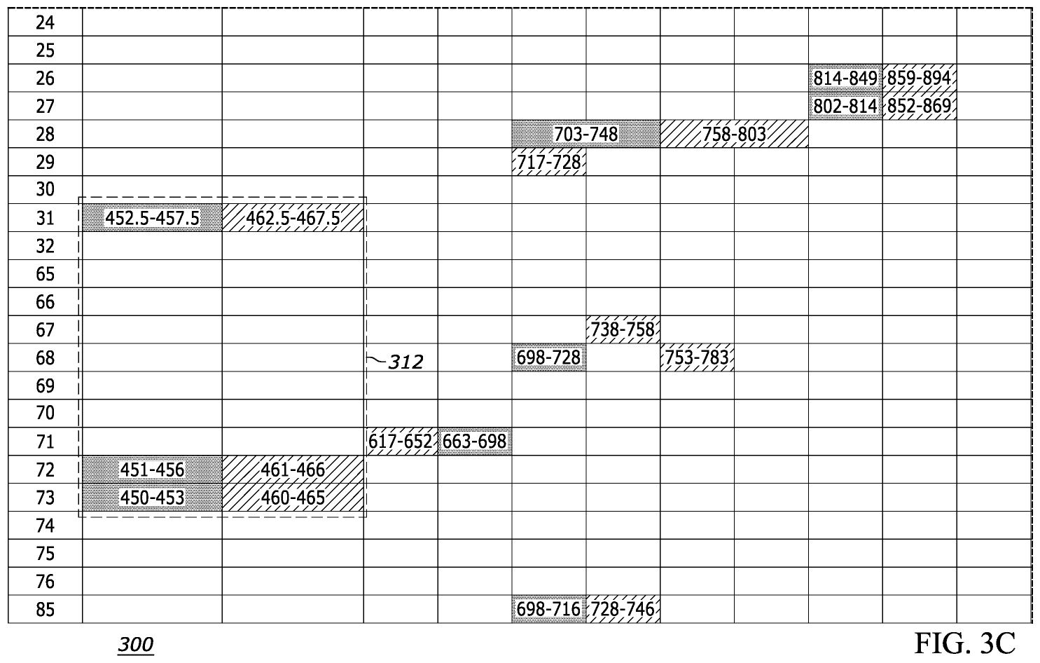

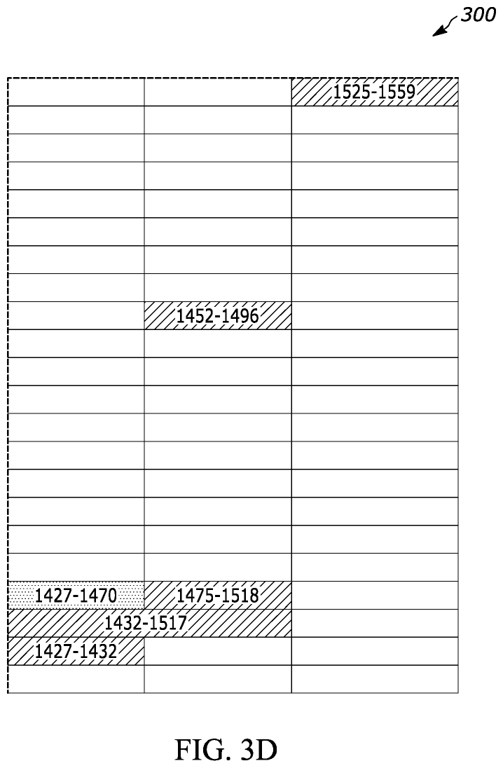

FIG. 3A illustrates the upper left quadrant of a schematic 300 of example Long Term Evolution (LTE) Frequency Division Multiplexing (FDD) bands. FIG. 3B illustrates the upper right quadrant of the schematic 300 of example Long Term Evolution (LTE) Frequency Division Multiplexing (FDD) bands of FIG. 3A. FIG. 3C illustrates the lower left quadrant of the schematic 300 of example Long Term Evolution (LTE) Frequency Division Multiplexing (FDD) bands of FIG. 3A. FIG. 3D illustrates the lower right quadrant of the schematic 300 of example Long Term Evolution (LTE) Frequency Division Multiplexing (FDD) bands of FIG. 3A. The different frequency allocations 302 for LTE are provided for each column across the top row of the schematic 300. Band numbers 304 for each allocation are provided for each row in the first column. Specific uplink bands in various frequency allocations are shown in shaded rectangles 306, while down link bands in various frequency allocations are shown in the other type of shaded rectangles 308.

In various service provider systems and/or generations of cellular technology, numerous different schemes are used to aggregate bands so that a single information signal, sometimes referred to as a data channel, uses two or more different bands. This is referred to as Carrier Aggregation (CA). For example the uplink and downlink bands in the two frequency allocations that are outlined in the dashed lines 310 can carry a single data channel or information signal. These are passed through a single antenna simultaneously. The signals are in disjoint frequency bands. There are multiple types of CA depending on the frequency difference between the aggregated bands. For example, the bands may be contiguous and in the same frequency allocation. The bands may also be non-contiguous, but in the same frequency allocation. The most challenging case is where the bands are in separate frequency allocations, which is the case of aggregation 310 shown in FIG. 3A.

Some services also utilize duplexer band aggregation (DBA) that enables two or more bands to be accessed via the same duplexer. In DBA, frequency bands for multiple uplink and downlink bands overlap. The dashed line 312 in FIG. 3C illustrates three different uplink/downlink bands with a common frequency allocation that can share a duplexer.

In a typical mode of operation, an uplink frequency band and a downlink frequency band are sent and received in pairs via a common antenna. The front end that connects the common antenna to the transmitter and receiver in, for example, a cellular device or base station, includes a frequency duplexer to separate signals from, and combine signals to, the antenna. A frequency duplexer is a three-port device that interfaces to the common antenna and routes the downlink signal to the input of the receive path while simultaneously conveying the output of the transmit path to the antenna.

Because of the tight spacing between the frequency bands—for example, uplink 306 and downlink 308 in FIG. 3A—the duplexer needs to have high selectivity. That is, the duplexer filter must have sharp cutoff at the edges of the passband. This high selectivity demands specialized filters, such as surface acoustic wave (SAW)-type filters. One of the constraints associated with using a SAW-type implementation is that the frequency response e.g., center frequency and frequency span, are fixed at the time of fabrication. Consequently, each frequency band pair needs its own duplexer. This was not an issue with early cellular telephony since only a few bands were available, and hence only a few SAW-type filters were required in cell phones.

However, the dramatic growth in the number of cell phone users and the amount of data each user needs has led to a demand for more spectrum to support these needs. Unfortunately large, contiguous spans of spectrum are simply not available. The result is that there are now more than forty paired frequency bands that are scattered throughout the spectrum, as illustrated by the sample of the spectrum shown in the frequency band schematic 300. Although it would appear that more than forty duplexers would be needed, a careful examination of the bands reveals that in some cases it is possible to have one duplexer cover more than one band. See, for example, box 312 on FIG. 3C. Hence it is possible to cover all forty bands with about twenty-one duplexers. However, even with duplexer band aggregation, a large number of duplexers is still required to cover all bands. The reduction in the number of duplexers to twenty-one is not sufficient to allow a practical cell phone configuration utilizing all bands given the extremely tight physical space constraint within a cell phone. As a result, it is currently impractical for manufacturers to offer a truly global phone, that is, one phone that can access all bands.

One solution is to construct a tunable duplexer that uses tunable filter technology instead of fixed filters. However, currently there is no such tunable filter technology suitable for this purpose that would provide the required tunability to maintain the present required frequency selectivity and be physically small enough to be suitable for integration into a cell phone.

One aspect of the present teaching is to provide a wireless front-end solution that can operate over all the present and future frequency bands in a configuration that eliminates all duplexers. These front end solutions utilize methods and apparatus according to the present teaching that suppress both internal and external interference in both primary, transmit/receive, antennas as well as diversity, receive-only antennas to allow a single wireless device (such as a cellular device) to transmit and receive over an arbitrary number of frequency bands, including those frequency bands illustrated in the schematic 300 as well as other frequency bands that are not shown in FIG. 3. The resulting wireless front-end provides a performance that not only meets, but also exceeds, the performance of a device that utilizes multiple frequency duplexers.

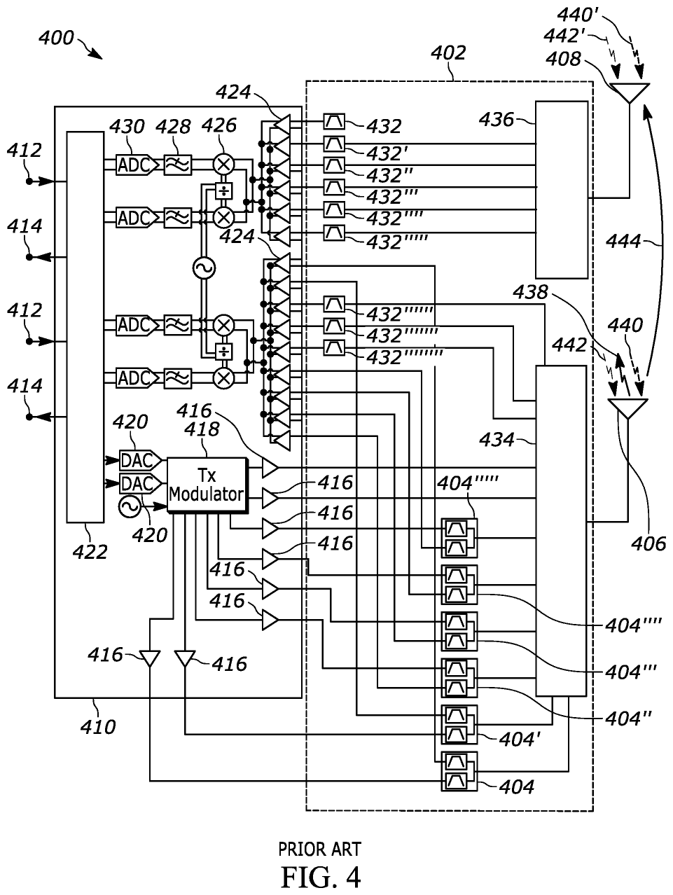

FIG. 4 illustrates a known RF system 400 that includes a front end 402 comprising multiple duplexers 404, 404′, 404″, 404′″, 404″″. 404′″″. The front end 402 connects antennas 406, 408 to a transceiver 410. The transceiver 410 connects to the front end 402 and to transmit paths 412 that provide an input transmit signal to the transceiver 410 and to receive paths 414 that provide the receive signal from the transceiver 410. The transmit section of the transceiver 410 includes transmit power amplifiers 416, a transmit modulator 418 and digital-to-analog converters (DAC) 420. A transmit/receive digital interface 422 provides formatting and timing needed to interface the typically serial data on 412 and 414 with the parallel data typically needed by ADC 430 and DAC 420. The receive section of the transceiver 410 includes low-noise receive amplifiers 424 that connect to receive outputs from the front-end 402. The receive amplifiers 424 are connected to mixers 426, filters 428 and analog-to-digital converters (ADC) 430. The ADCs 430 provide a digital receive signal to the transmit/receive digital interface 422 that in turn provides a receive signal at the receive path outputs 414. The front end 402 includes a number of fixed band pass filters 432, 432′, 432″, 432′″, 432″″, 432′″″, 432″″″, 432′″″″ that each pass a particular band of the FDD frequency bands. The primary antenna 406 connects to the duplexers 404, 404′, 404″, 404′″, 404″″. 404′″″ and the transceiver 410 using switch 434. The diversity antenna 408 connects to the fixed band pass filters 432, 432′, 432″, 432′, 432′″, 432′″″, 432′″″, 432′″″″ and the transceiver 410 using switch 436.

In operation, the primary antenna 406 produces a transmit signal 438 and receives receive signals 440. The diversity antenna receives receive signals 440′. In general, receive signals 440, 440′ carry the same information on the same RF frequency channel. However, the receive signals 440, 440′ follow different physical channels because the two antennas 406, 408 are physically distinct and located at different positions. Both antennas receive interference signals 442, 442′. In addition, the diversity antenna 408 receives an interference signal 444 that is generated by the primary antenna transmit signal 438. The switches 434, 436 may be active coupling devices, such as active switches or couplers, or can be passive couplers.

The RF front end 402 is implemented with one duplexer 404, 404′, 404″, 404′″, 404″″, 404′″″ per paired-bands of frequency. Also, the RF front end 402 includes fixed band pass filters 432, 432′, 432″, 432′″, 432″″, 432′″″, 432″″″, 432′″″″ for most of the paired-bands of frequency and some other bands that are needed to process receive signals. Clearly using duplexers and fixed band pass filters for each band is not a scalable solution as the number of bands grows. Presently there is no technology that will enable a filtering-based approach to meet the needs of present and future systems. Methods and apparatus of the present teaching utilize a new approach to frequency-agnostic wireless radio-frequency front ends that does not involve filtering.

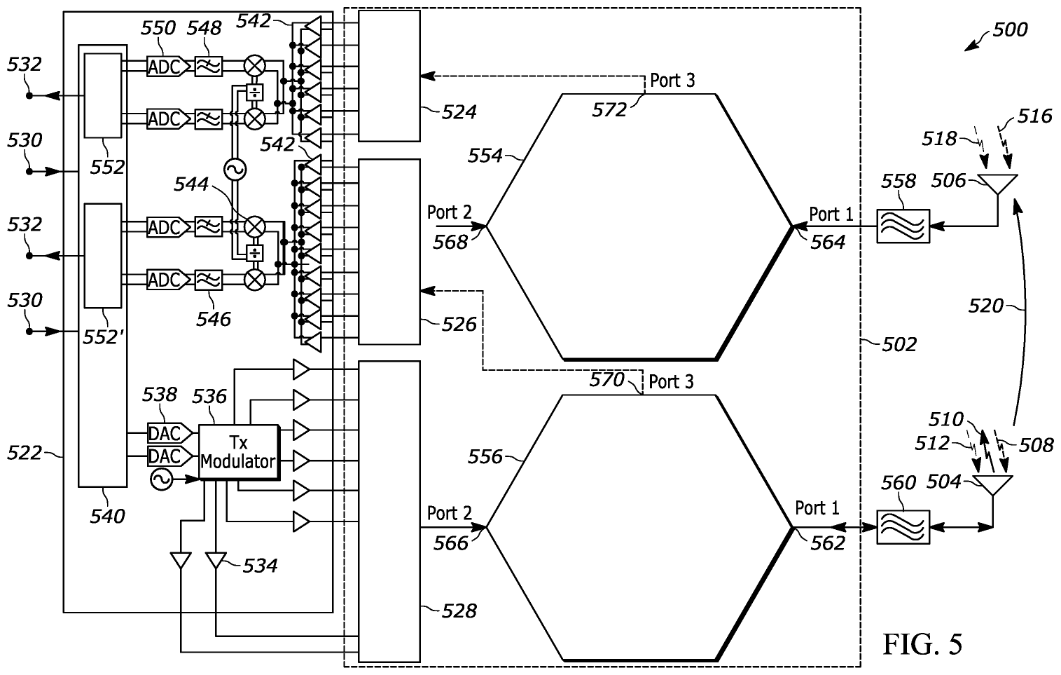

FIG. 5 illustrates an embodiment of an RF system 500 that includes a frequency-agnostic front end 502 according to the present teaching. This RF system 500 configuration includes a primary antenna 504 and a diversity antenna 506. First, it is important to appreciate that there are actually two sources of interference at the antennas 504, 506. One source of interference is generated internally in the RF system 500. The other source of interference is generated externally. FIG. 5 illustrates a desired receive signal 508, a desired transmit signal 510 and an external interference signal 512 all in electromagnetic communication with the primary antenna 504. Also illustrated are a desired receive signal 516 and an external interference signal 518 in electromagnetic communication with the diversity antenna 506. In addition, there is an internal interference signal 520 at the diversity antenna 506 that is generated by radiation from the primary antenna 504.

As described herein, internal interference arises when the relatively high-power, internal transmit signal enters the internal high sensitivity receive path. This internal interference can enter via several paths, such as coupling from the internal transmit antenna, or leakage through the internal interface (from, for example, a ferrite circulator) that interfaces between the antenna and the transmit/receive paths. Internal interference is illustrated in FIG. 5 as the coupling from the internal transmit antenna, which is the primary antenna 504, into diversity antenna 506 by interference signals designated by arrow 520.

Thus, for internal interference, there are two topologically distinct cases to consider. The first is interference coming from the primary antenna 504 that is both transmitting and receiving and the second is interference coming from the diversity antenna 506 that is only receiving. The external interferences 512, 518 shown enter both of these antennas 504, 506. The main difference is that since the diversity antenna 506 does not radiate a transmit signal like the primary antenna 504, the diversity antenna 506 needs only a uni-directional path from the antenna.

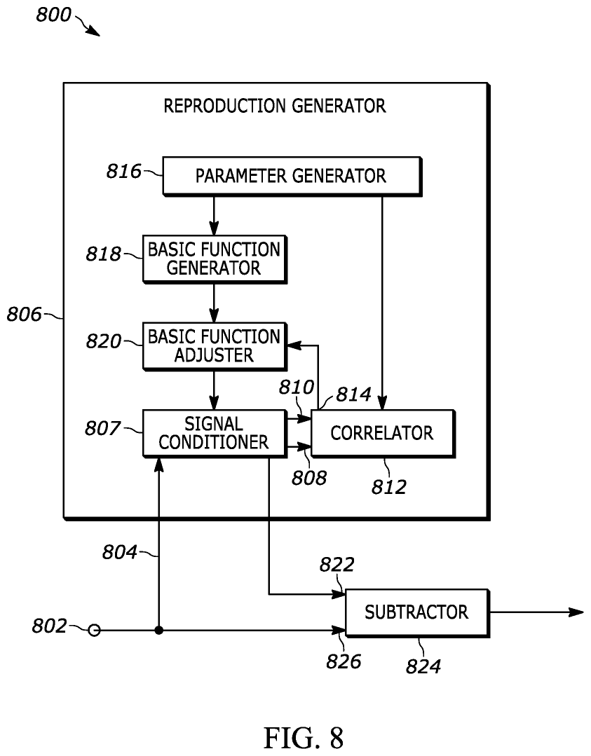

To illustrate the benefits of the front end 502 described in connection with FIG. 5, the front end is shown integrated into a system that would operate similar to the system 400 of FIG. 4. In particular, the front end 502 is coupled to a transceiver 522 using three switches 524, 526, 528. Transceiver 522 is similar to transceiver 410 of FIG. 4. The transceiver 522 includes ports that support the input transmit paths 530 and output receive paths 532. The transmit section of the transceiver 522 includes transmit amplifiers 534, a transmit modulator 536 and digital-to-analog converters (DAC) 538. A transmit/receive digital interface 540 provides formatting and timing needed to interface the typically serial data on 530 and 532 with the parallel data typically needed by ADC 550 and DAC 538. In the receive section of transceiver 522 receive amplifiers 542 connect to the front end 502 via switches 524, 526. Mixers 544, filters 546, 548 and ADCs 550 are connected to a transmit/receive digital interface 540. The transmit/receive digital interface 540 includes external interference reducer processors 552, 552′ that connect to the ADCs 550. The external interference reducer processors 552, 552′ are described in more detail in connection with FIG. 8. Some embodiments of external interference reducer processor 552, 552′ execute a self-isolating reference (SIR) algorithm, as described herein. The external interference reducer processors 552, 552′ are used to improve the rejection of interference from both known and unknown, or partially known interference sources. By partially known, we mean that, for example, the modulation signal or data information is not known, but the modulation format and/or multiplexing format is known.

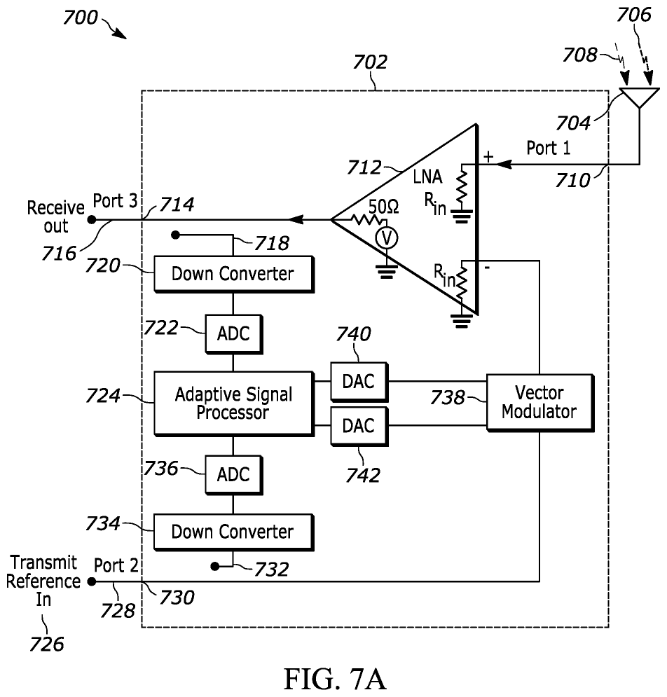

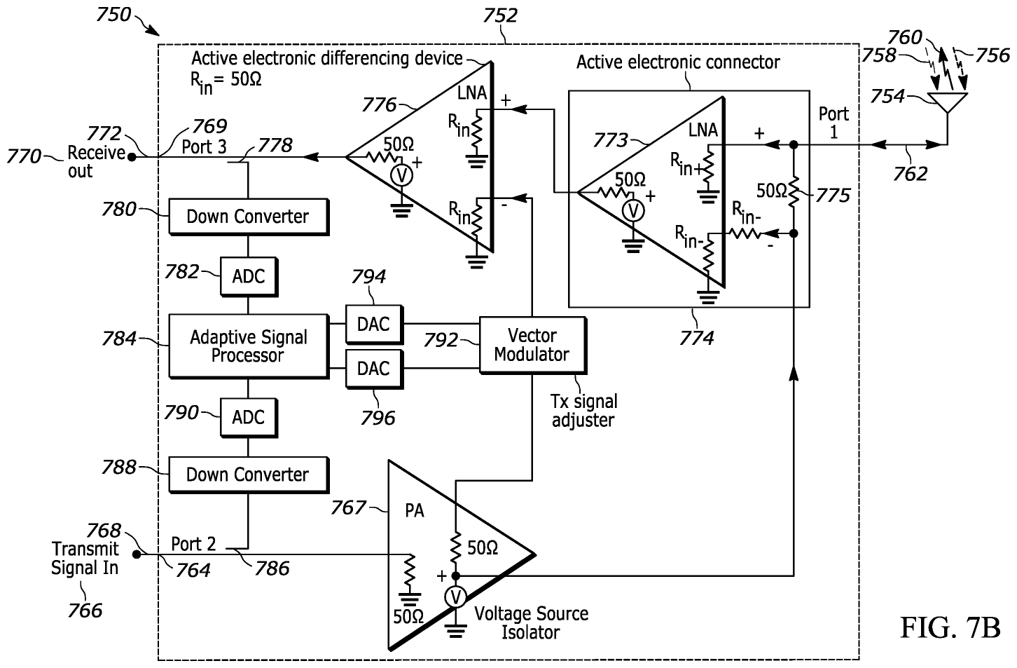

This configuration includes two frequency-agnostic front end devices, one for each of the two types of antennas: one that transmits and receives 504, and one that is receive-only 506. A receive front end of the present teaching 554 connects the diversity antenna 506 to the transceiver 522. A transmit-receive front end 556 connects the primary antenna 504 to the transceiver 522. The transmit and receive front end 556 may also be referred to as a connector-based front end in the sense defined in U.S. Pat. No. 9,935,680, entitled “Same-Aperture Any-Frequency Simultaneous Transmit and Receive Communication System”. The front ends 554, 556 connect to respective antenna 506, 504 via respective antenna matching circuit 558, 560, which are optional. Each front end 556, 554 has a first port 562, 564 for connecting to the antenna 504, 506, a second port 566, 568 for receiving a transmit signal or a reference transmit signal, and a third port 570, 572 for providing a receive signal. A transmit signal can be received directly from the transceiver 522, as in the case of transmit and receive front end 556. The transmit signal can be a transmit reference signal that can be input from a processor (not shown), as in the case of receive front end 554. The third port 570, 572 supplies the receive signal to the transceiver 522, via switches 524, 526. Receive front end 554 includes a canceller 574 that has individual connections to each of the first port 564, second port 568 and third port 572; details of its operation will be explained in conjunction with FIGS. 7A, 11 and 13. Transmit and receive front end 556 includes a connector 580 that has individual connections to each of the first port 564, second port 566 and third port 570; details of transmit and receive front end 556 operation will be explained in conjunction with FIGS. 7B, 9, 10 and 12.

As described herein, external interference arises when the high-power transmit signal of external systems, which may be co-located with a particular system, enters the particular system's sensitive receive path. Specifically, the coupling from the external systems into diversity antenna 506 is illustrated by interference signal designated by arrow 518. The coupling from the external systems into primary antenna 504 is illustrated by the interference signal designated by arrow 512. The transmit signal from primary antenna 504 that causes internal interference in diversity antenna 506 is illustrated by arrow 520. The receive signal, which is sometimes referred to as the desired receive signal or desired signal, enters the primary antenna 504 as illustrated by arrow 508, and enters the diversity antenna 506 as illustrated by arrow 516.

As compared the RF system 400 described in connection with FIG. 4, the RF system 500 of FIG. 5 provides clear advantages in that it eliminates the multiple duplexers 404, 404′, 404″, 404′″, 404″″. 404′″″ and fixed bandpass filters 432, 432′, 432″, 432′″, 432″″, 432′″″, 432″″″, 432′″″″. The embodiment of the system 500 of FIG. 5 includes multiple power amplifiers 534 and multiple low-noise receive amplifiers 542 that are also used in the known system 400 described in connection with FIG. 4.

Thus, the RF system 500 suppress both external interference sources 512, 518 and internal interference 520 from the transmit signal. The RF system 500 benefits from an innovative combination of two technologies. For the internal interference, which is filtered out by a frequency-selective duplexer in prior art systems, the techniques of the present teaching use the transmit or uplink signal, a reference copy of the internal interference, parameters derived from the transmit or uplink signal, or parameters derived from the reference copy. Since interference suppression of the present teaching uses the signal causing the internal interference, or parameters derived from it, to suppress the interference—rather than filtering as is used in prior art suppression systems—the amount of suppression is independent of the frequency at which the interference occurs. Hence using the suppression techniques of the present teaching, there is no need for a minimum frequency separation between the interference and desired signals as there was when using prior art suppression techniques. The minimum frequency separation results in guard bands, which are regions of the spectrum between signals that allow for separation of signals using frequency filters. Guard bands are presently technically necessary for FDD systems, but economically unproductive. Systems and methods of the present teaching result in guard bands being significantly reduced, or even eliminated. This advantageously makes the present guard band frequencies available for re-assignment to revenue generating transmit and/or receive bands.

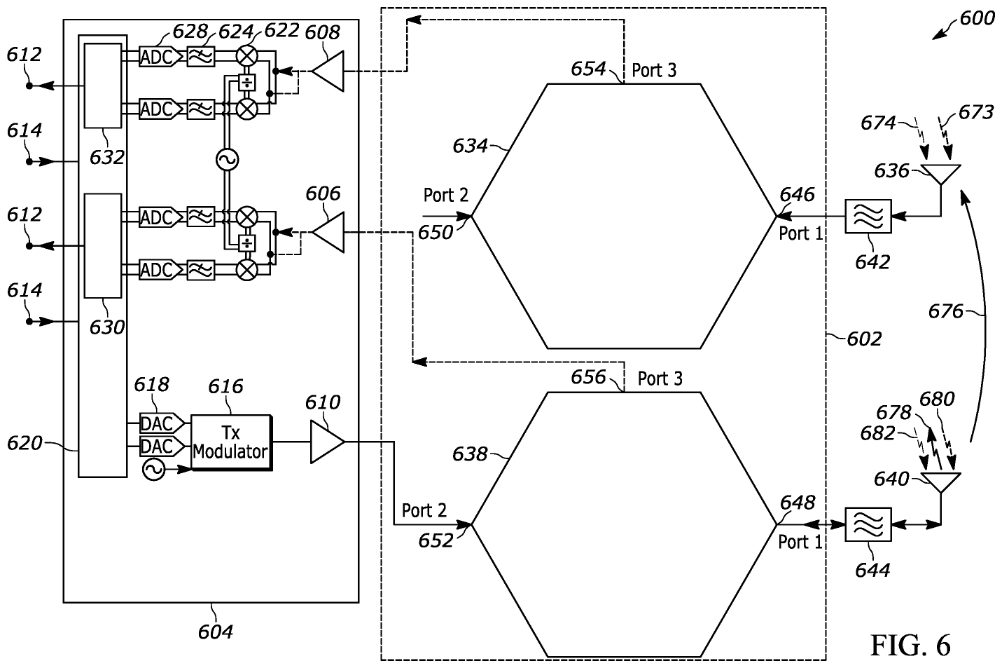

Some embodiments of the frequency-agnostic wireless radio-frequency front end of the present teaching even further reduce the number of components needed to provide a multi-band RF system by, for example, utilizing common amplifiers. FIG. 6 illustrates an embodiment of an RF system 600 that includes a frequency-agnostic front end 602 comprising common amplifiers according to the present teaching. The embodiment of the RF system 600 of FIG. 6 is similar to the RF system 500 described in connection with FIG. 5, except that it uses fewer components. The frequency-agnostic front end 602 is coupled to a transceiver 604 via a primary common low-noise amplifier 606, a diversity common low-noise amplifier 608, and a common transmit power amplifier 610. The common amplifiers 606, 608, 610 amplify their respective signals in all bands simultaneously, rather than separate amplifiers being used for each band as described in connection with the systems shown in FIGS. 4 and 5.

The transceiver 604 includes ports that support input transmit paths 614 and output receive paths 612. The transmit section of the transceiver 604 also includes a transmit modulator 616 and digital-to-analog converters (DAC) 618. A transmit/receive digital interface 620 provides formatting and timing needed to interface the typically serial data on 612 and 614 with the parallel data typically needed by the ADC 628 and DAC 618. There is only one transmit power amplifier 610 connected to the modulator 616. The receive section of transceiver 604 includes mixers 622, filters 624, and ADCs 628. The transmit/receive digital interface 620 includes interference reducer processors 630, 632 that connect to the ADCs 628. The interference reducer processors 630, 632 are described in more detail in connection with FIG. 8. The interference reducer processors 630, 632 are optional, and are used to improve the rejection of interference from both known and unknown, or partially known interference sources. By partially known we mean that some information is known while other information is not known. For example, the modulation signal or data information can be unknown, while the modulation format and/or multiplexing format is known.

A receive-only front end 634 connects a diversity antenna 636 to the transceiver 604. A transmit and receive front end 638 connects a primary antenna 640 to the transceiver 604. The front ends 634, 638 connect to respective antennas 636, 640 via antenna matching circuits 642, 644, that are optional. Each front end 634, 638 has a first port 646, 648 for connecting to the respective antenna 636, 640, and a second port 650, 652, for receiving a transmit signal or a reference transmit signal, and a third port 654, 656 for providing a receive signal. A transmit signal can be received directly from the transceiver 604, through a second port 652, as in the case of transmits-receive front end 638. In the case of receive front end 634, the input to the second port 650 can be a transmit reference signal that can be provided by a processor (not shown) or by an internal transmit source reference, depending on the nature of the transmit signal interference being cancelled. The third ports that supply receive signals include third ports 654, 656 that supply the receive signal to their respective common receive low power amplifiers 608, 606.

Operation of the receive front end 634 will be described in detail in conjunction with FIGS. 7A, 11 and 13. Operation of transmit and receive front end 638 will be described in detail in conjunction with FIGS. 7B, 9, 10 and 12.

In some embodiments, at least some of the undesired external interference signals collected by antenna 640 that are passed to the third port 656 are cancelled in the interference reducer processor 630. The interference reducer processors 630, 632, receive front end 634, and transmit and receive front end 638 are all configured to be inherently broad band enough to be capable of providing their full function over any or all of the frequency bands used in cellular communications. In some embodiments, the frequency bands are the FDD LTE frequency bands. In other embodiments, the frequency bands are all the international standard frequency bands for cellular communications.

FIG. 7A illustrates an embodiment of an RF system 700 that includes a frequency-agnostic receive front end 702 for a diversity antenna 704 according to the present teaching. The diversity antenna 704 receives receive signals 706 and interference signals 708. The internal interference is suppressed by frequency-agnostic front end 702; the external interference is assumed to be of sufficiently low enough power that it passes through to the output 714 and eventually to the interference reducer processors 552, 552′, 630, 632 in FIGS. 5 and 6 respectively where it is suppressed. The diversity antenna 704 is electrically connected to the first port 710 of the frequency-agnostic receive front end 702. The first port 710 connects to an input of an electronic differencing device 712, which in this embodiment comprises a low noise amplifier. The output of differencing device 712 is connected to the third port 714, which provides a receive output signal along a receive signal path 716. Part of the output signal from differencing device 712 is split at splitter 718 and sent to a down converter 720 that translates the frequency spectrum of the signal down to a lower frequency, which can be an intermediate frequency (IF) or baseband. The down-converted signal is sent to an analog-to-digital converter 722 and adaptive signal processor 724.

A transmit reference input signal 728 is provided along a transmit signal path 728 through the second port 730 of the frequency-agnostic receive front end 702. Part of this transmit reference signal 726 is split off at splitter 732 and provided to a down converter 734, analog-to-digital converter 736, and to the adaptive signal processor 724. The other part of the transmit reference input signal 726 is sent to a vector modulator 738. The output of the vector modulator 738 is connected to the negative input of differencing device 712. The adaptive signal processor 724 is used to correlate the reference transmit signal with the output of differencing device 712 to isolate interfering transmit components in the receive signal at the differencing device 712 output. The adaptive signal processor 724 then forms an estimate of the optimum complex value of the reference transmitter signal that needs to be injected into the differencing device 712 so as to minimize the residual interfering transmitter signal that is present at the differencing device 712 output.

The adaptive signal processor 724 generates two signals at a first and second output that contain the desired settings on the transmit signal adjuster. The first and second signals generated at the output of the adaptive signal processor 724 are provided to respective digital-to-analog converters 740, 742. The digital-to-analog converters 740, 742 generate analog outputs that are sent to vector modulator 738. Some vector modulators include these digital-to-analog converters. Depending on the implementation, the vector modulator 738 may include complex settings for the in-phase (I) and quadrature (Q), or for the magnitude and phase, portions of the transmit reference signal.

In this embodiment, the frequency-agnostic receive front end 702 is a cancelling front end. That is, the first port 710 is a unidirectional port, and only receives signals from antenna 704. The second port 730 takes in a transmit reference signal that is used to remove residual transmit interfering signals that are collected by antenna 704. There is no transmit signal that is passed from the second port 730 to first port 710 to be sent by antenna 704 because antenna 704 is a receive-only antenna.

FIG. 7B illustrates an embodiment of an RF system 750 that includes a frequency-agnostic transmit and receive front end 752 for a primary antenna 754 according to the present teaching. The frequency-agnostic transmit and receive front end 752 for the primary antenna 754 has many of the same components as the front end 702 for the diversity antenna 704 described in connection with FIG. 7A. However, transmit and receive front end 752 for the primary antenna 754 supports the simultaneous transmission of a transmit signal with receipt of a receive signal at antenna 754. As such, the antenna 754 collects signals that include a desired receive signal 756 as well as received interference signals 758. Antenna 754 also propagates transmit signal 760. Thus, the first port 762 is a bidirectional port. The second port 764 connects to a transmitter (not shown) and accepts an input transmit signal 766 on a transmit signal path 768 that connects to an input of an isolating power amplifier 767. In this embodiment, the isolator is an isolating power amplifier with a voltage source isolator. The third port 769 connects to a receiver (not shown) and provides a receive signal 770 on a receive signal path 772.

A connector 774 includes a low noise amplifier 773 with two input ports connected in parallel to a 50 ohm resistor 775. The first port 762 is connected to an input of the low noise amplifier 773 and the 50 ohm resistor 775. The lower impedance, ideally zero, output of isolating power amplifier 767 is connected to an input of the low noise amplifier 773 and the 50 ohm resistor 775. The input resistance, Rᵢₙ can be greater than 50 Ohms in some configurations. The voltage divider on the negative input is shown as being ½, which is the ideal value assuming that the antenna impedance equals the 50 Ohms of resistor 775. In practice, the actual antenna impedance may differ from 50 Ohms. As is well known by those skilled in the electrical circuit design art, the voltage divider on the negative input would need to be changed to give the same voltage divider ratio as the voltage divider formed by the 50 Ohm resistor 775 and the antenna impedance. Connector 774 is inherently broadband and capable of connecting the respective signals from first port 762 to the differencing device 776 and from the isolating power amplifier 767 at multiple frequency bands, such as any of the frequency bands used in cellular communications.

The output of differencing device 776 is connected to the third port 769, which provides the output receive signal path 772. Part of the output signal from differencing device 776 is split at splitter 778 and sent to a down converter 780 that translates the frequency spectrum of the signal down to a lower frequency, which can be an intermediate frequency (IF) or baseband. The down-converted signal is sent to an analog-to-digital converter 782 and then to the adaptive signal processor 784.

Transmit input signal 766 is provided to the second port 764 of the transmit and receive front end 752. Part of this signal is split off at splitter 786 and provided to a down converter 788, analog-to-digital converter 790, and to the adaptive signal processor 784. The other part of the transmit input signal 766 is sent to an isolating power amplifier 767. The higher impedance output, which is 50 Ohms in this example, of the isolating power amplifier 767 is connected to a vector modulator 792. The adaptive signal processor 784 is used to correlate the transmit signal 766 with the output of differencing device 776 to isolate the residual transmitter component in the differencing device 776 output. The adaptive signal processor 784 then forms an estimate of the optimum complex value of the transmitter signal that needs to be injected into the differencing device 776 so as to minimize the residual or at least partially block the transmitter signal that is present at the output of the differencing device 776.

The output of the adaptive signal processor 784 includes two signals that contain the desired settings on the transmit signal adjuster. Since many vector modulators require analog inputs, outputs of the adaptive signal processor 784 comprising these two signals are provided to respective digital-to-analog converters (DACs) 794, 796, but some configurations of vector modulators include the digital-to-analog converters. The analog outputs from the DACs are sent to vector modulator 792. Depending on the implementation of the vector modulator 792, the complex settings from the adaptive signal processor 784 may be represented as the in-phase (I) and quadrature (Q), or for the magnitude and phase, portions of the transmit reference signal. The output of vector modulator 792 is provided to the negative input port of differencing device 776.

One feature of RF systems comprising apparatus and methods of the present teaching is that they can substantially reduce or eliminate interference from sources in which the format, but not the data, of the transmitted signal is known. That is the situation, for example, when no actual reference copy is available for the transmit signal, such is often the case for externally-generated interference signals. In current state-of-the art systems, these externally-generated interfering transmit signals are filtered out by the out-of-band rejection of the frequency-selective duplexer. To eliminate the duplexer, an alternative method is needed to eliminate or reduce substantially the undesired, externally-generated signals. In embodiments for which no reference copies of externally generated interfering signals are available, we need to use an interference cancellation technique that does not require a reference signal. One such technique is described in U.S. Pat. No. 10,158,432, entitled “RF Signal Separation and Suppression System and Method”, which is incorporated herein by reference. These techniques utilize an algorithm referred to as a Self-Isolating Reference (SIR) algorithm.

FIG. 8 illustrates an embodiment of a frequency-agnostic interference reducer processor 800 of the present teaching. The interference reducer processor 800 can be used, for example, as the interference reducer processors 552, 552′, 630, 632 described in connection with FIGS. 5 and 6. The interference reducer processor 800 can use the reproduction-based RF signal separation and suppression described in U.S. Pat. No. 10,158,432, entitled “RF Signal Separation and Suppression System and Method”. An input 802 of the interference reducer processor 800 couples in signals that comprise desired and undesired signals. The desired signals are also referred to herein as receive signals. The undesired signals are referred to herein as externally-generated interference signals. The input 802 is electrically connected to an input 804 of a reproduction generator 806. The reproduction generator 806 includes a signal conditioner 807 having an input that is connected to the input 804. The signal conditioner 807 includes a first output connected to a first input 808 and a second output that is connected to a second input 810 of a correlator 812. The correlator 812 performs correlation of signals provided to the first 808 and second 810 inputs. The correlation is generated at an output 814 of the correlator 812.

The reproduction generator 806 includes a parameter generator 816 that provides basis function parameters to a basis function generator 818. One skilled in art will appreciate that a basis function is an element of a particular basis for a function space. Every continuous function in the function space can be represented as a linear combination, with proper weighting, of basis functions. In some methods according to the present teaching, the function of interest is the signal to be separated. The parameter generator 816 also provides parameters to the correlator 812. The parameters provided by the parameter generator 816 include the signal parameters of the signal to be separated. In some embodiments, if the desired signals are to be separated, then their signal parameters are generated by the parameter generator 816. In some embodiments, if the undesired signals are to be separated, then their signal parameters are generated by the parameter generator 816.

Using the parameters provided by the parameter generator 816, a basis function generator 818 produces the desired functional representation of the aggregate of the signals to be separated as a linear combination of weighted basis functions. In some embodiments, using the parameters provided by the parameter generator 816, a basis function generator 818 produces the carrier(s) and subcarrier(s) of the signal to be separated. The output of the basis function generator 818 is connected to one input of a basis function adjuster 820. A second input of the basis function adjuster 820 is connected to the output 814 of the correlator 812. The basis function adjuster 820 output is connected to a second input of the signal conditioner 807. The basis function adjuster 820 adjusts the weighting of the basis functions, which in some methods according to the present teaching comprises the amplitudes and the phases of the carrier(s) and subcarrier(s) provided by the basis function generator 818, in order to maximize the correlation between the output of the reproduction generator and the sum of the signal(s) to be separated and the signal(s) to be kept.

A third output of the signal conditioner 807 is the output of the reproduction generator 806. The output of the reproduction generator 806 is electrically connected to a first input 822 of a subtractor 824. The input 802 of the interference reducer processor 800 is electrically connected to the second input 826 of the subtractor 824. The subtractor 824 subtracts the reproduction of the signal to be separated from the sum of the signal(s) to be kept and the signal(s) to be separated. The output of the subtractor 824 provides an output signal that includes the signal(s) to be kept with the signal(s) to be separated suppressed. Thus, the output signal from the interference reducer processor 800 includes the desired signal(s) and a suppressed aggregate of the undesired signal(s).

In some embodiments, the reproduction generator 806 performs a self-isolating reference (SIR) algorithm using three steps. In the first step, the basis function generator 818 generates the basis function(s) of the signal to be separated. In the second step, the basis function adjuster 820 adjusts the signals provided by the basis function generator 818. In the third step, the correlator 812 performs the correlation. The adjuster 820 operates in conjunction with the correlator 812 to maximize the correlation between the output of the reproduction generator 806 and the sum of the signal to be separated and the signal to be kept. For use in the RF system that includes the frequency-agnostic front end embodiments described in connection with FIGS. 5-6, the frequency-agnostic interference reducer processor 800 operates with signals in digital form. In various embodiments, the functions and/or steps associated with the interference reducer processor 800 can be performed in analog and/or digital form.

One important feature of the interference reducer processor 800 of the present teaching is that it only requires information about the signal format including, for example, the multiplexing and physical layer transmission format (e.g. carriers), of the interference signals to render a portion of the interference signal(s) distinguishable and thus, separable and/or suppressible. Thus, frequency-agnostic the interference reducer processor 800 of the present teaching is effective at suppressing the undesired signals irrespective of the data that are being conveyed by that format. In cellular telephony systems according to the present teaching, the format of the multiplexing and physical layer transmission is standardized and well known. As a particular example, consider the case where the up-link signals being transmitted by mobile users who are co-located with a particular user constitute the externally-generated interference that is incident on the antennas of a particular user's cell phone. In such a case the format of the externally-generated interference is well known, since it follows the known standards for cell phone up-links.

The frequency-agnostic interference reducer processor 800 can be implemented in RF systems that include a frequency-agnostic front end 500, 600 that are described in connection with FIGS. 5-6. The input 802 can be electrically connected to the output of the analog-to-digital converters 550, 628. The output of the subtractor 824 is connected to output receive path 532, 614.

One feature of the present teaching is the frequency-agnostic interference reducer processor 800 has a broad bandwidth, such that any or all of the frequency bands of a particular cellular system, such as an FDD-based cellular system, can be appropriately processed by the interference reducer processor 800. Therefore, the input 802 of the interference reducer processor 800 couples in signals that include desired and undesired signals that occupy a variety of signals in one or more of multiple frequency bands of cellular systems. The desired and undesired signals can occupy the same frequency bands and/or different frequency bands. This reduces component count and size of a front end as compared to known front ends that rely on filtering or filtering frequency duplexers to reduce the content of undesired signals in a signal that contains a desired signal. In some embodiments, these include signals in FDD frequency bands for cellular systems.

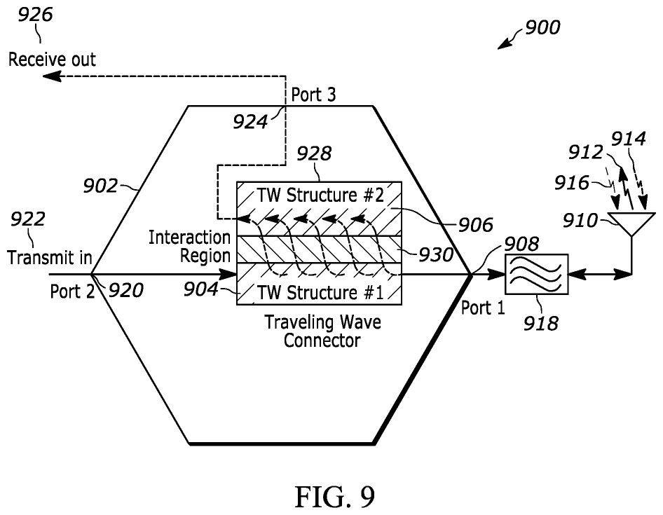

FIG. 9 illustrates an embodiment of an RF antenna system 900 comprising a frequency-agnostic transmit and receive front end 902 that utilizes travelling wave structures 904, 906 to form a connector according to the present teaching. For example, the connector can be one of the connectors described in U.S. Pat. No. 7,555,219, which is assigned to the present assignee, and which is incorporated herein by reference. The first port 908 connects to an antenna 910, which is a primary antenna that produces a transmit signal 912 and that collects a desired receive signal 914 and undesired interference signals 916. In some embodiments, the primary antenna 910 is a cellular system primary antenna. The connection to the antenna 910 may pass through an antenna matching circuit 918, which causes a part of the transmit signal to be reflected back on bi-directional path where it enters the connector thereby producing an internally-generated interference that needs to be suppressed.

The transmit and receive front end 902 has a first port 908 for connecting to the antenna 910 that is bidirectional, and a second port 920 for taking in a transmit signal 922, and a third port 924 for providing a receive signal and the externally-generated interference 926 out. The transmit and receive front end 902 includes a non-reciprocal waveguide device 928 having a first 904 and a second 906 traveling-wave waveguide that are positioned such that electromagnetic fields couple in an interaction region 930 between the first traveling-wave waveguide 904 and the second traveling-wave waveguide 906 in a non-reciprocal manner. The term “non-reciprocal manner” is as used herein to mean non-reciprocal coupling of electromagnetic fields where electromagnetic fields strongly coupled in one direction and are substantially prevented from coupling in another direction, such as in a circulator device. In some embodiments, the non-reciprocal waveguide device 928 is an optical modulator. In other embodiments, the non-reciprocal waveguide device 928 is an electronic distributed amplifier.

The non-reciprocal waveguide device 928 passes a transmit signal 922 from the second port 920 to the first port 908. Simultaneously, the non-reciprocal waveguide device 928 passes a receive signal and externally-generated interference signal(s) from the first port 908 to the third port 924 while not passing the transmit signal from second port 920 to the third port 924. The non-reciprocal waveguide device 928 also prevents the passage of the receive signal and externally-generated interference signal(s) from the first port 908 to the second port 920.

One feature of the present teaching is the use a non-reciprocal waveguide device 928 with broad RF spectral bandwidth, such that any or all of the frequency bands of a particular cellular system, such as an FDD-based cellular system, are appropriately passed amongst the first port 908, second port 920 and the third port 924 as described. Therefore, the second port 920 can pass transmit signals on one or more of multiple frequency bands for cellular transmit signal bands to the first port 908 while the third port 924 passes receive signals on one or more of multiple frequency bands for cellular receive signal bands from the first port 908.

The one or more frequency bands for transmit and receive can be spectrally disjoint, and/or can have overlapping spectra. In some embodiments, the transmit signal and the receive signal occupy the same cellular frequency band at the same time. In other embodiments, the transmit signal and the receive signal occupy different cellular frequency bands at the same time. For example, the transmit signal 922 can be a cellular uplink channel for an FDD system while the receive signal 926 is a cellular downlink channel for an FDD system, or vice versa. Even in the case where the transmit signal 922 and the receive signal 926 occupy disjoint cellular frequency bands, the signal separation occurs without the use of filtering, or filtering frequency duplexers to separate the transmit and the receive signals. This reduces component count and size of the front end 902 as compared to known front ends that rely on filtering or filtering frequency duplexers. In some embodiments, the front end 902 is used as the primary antenna front end 556, 638 for the system described in connection with FIGS. 5-6.

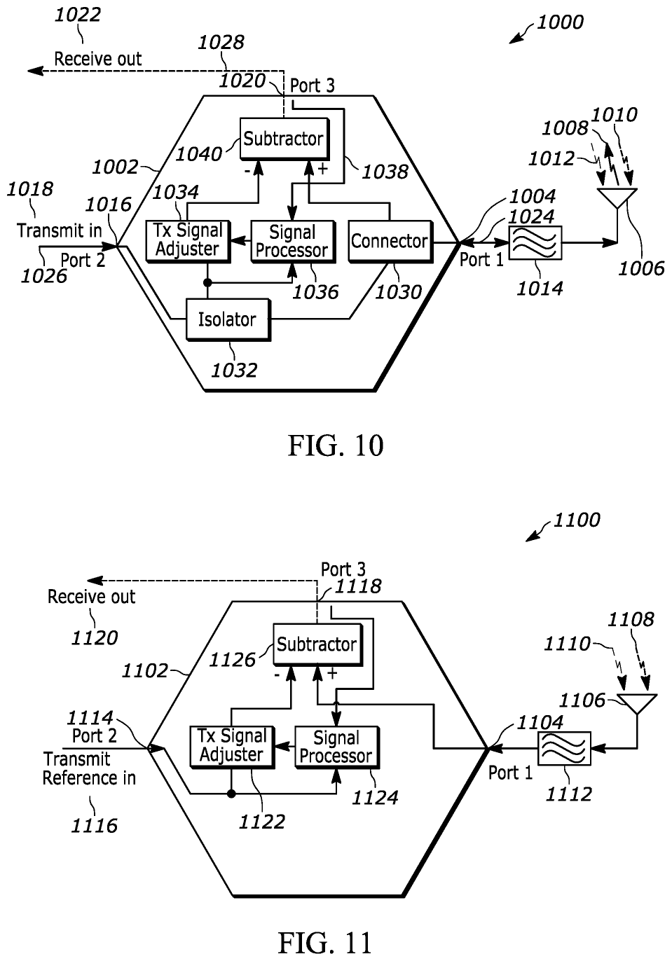

FIG. 10 illustrates an embodiment of an antenna system 1000 with a frequency-agnostic transmit and receive front end 1002 that utilizes subtraction according to the present teaching. The first port 1004 connects to an antenna 1006 via bi-directional path 1024. The antenna 1006 is a primary antenna producing a transmit signal 1008 and collecting a desired receive signal 1010 and undesired interference signals 1012. In some embodiments the primary antenna 1006 is a cellular system primary antenna. The connection from the first port 1004 to the antenna 1006 may pass through an antenna matching circuit 1014, which causes a part of the transmit signal 1018 to be reflected back on bi-directional path 1024 where it enters the connector 1030 thereby producing an internally-generated interference that needs to be suppressed.

The front end 1002 also has a second port 1016 for inputting a transmit signal 1018, and a third port 1020 for providing a receive signal 1022. Thus, the transmit and receive front end 1002 connects three signal paths via the first port 1004, the second port 1016 and the third port 1020. These paths are a bidirectional signal path 1024 from and to the antenna 1006, a transmit path 1026, and a receive path 1028. The first port 1004 connects the antenna 1006 to a first port of a signal connector 1030. An isolator 1032 is connected between the second port 1016 and a second port of the signal connector 1030.

The combined tap and isolator 1032 also provides a portion of the transmit signal 1026 to a transmit signal adjuster 1034 and to a signal processor 1036. Alternatively, as is well known in the RF art, the tap and isolator can be implemented using separate components. The signal processor 1036 also has an input 1038 that is connected to the third port 1020, and also provides an output to the transmit signal adjuster 1034. A third port of the signal connector 1030 is input to a subtractor 1040. In various embodiments, the signal connector 1030 is one of the connectors described in U.S. patent application Ser. No. 14/417,122, entitled “Same-Aperture Any-Frequency Simultaneous Transmit and Receive Communication System.” For example, the signal connector 1030 can be configured so that the impedance at each port of the signal connector 1030 is designed to match the impedance of the component that is connected to that respective port, which can be the antenna 1006, the isolator 1032, and the subtractor 1040.

The output of the subtractor 1040 is also connected to the signal processor 1036 via path 1038. In operation, the subtractor 1040 removes the large transmit signal 1018 from the receive signal passed by the connector 1030. The signal-processed and adjusted transmit signal is derived from the input transmit signal 1018. The signal processor 1036 determines the precise complex value of the transmit signal that should be fed to the second terminal of the subtractor 1040 so as to minimize the residual transmit signal that is present in the receive path. The transmit signal adjustor 1034 is used to set the complex value of the transmit signal that is fed to the subtractor 1040.

Thus, only the receive signal and the externally-generated interference signal(s) are present at the third port 1020, with the transmit signal 1018 removed. This is true regardless of whether the frequency bands of the transmit and receive signals are in the same or disjoint portions of the spectrum. The separation occurs without the need for any filtering or frequency duplexer between the first port 1004 and the second port 1016 and/or the third port 1020.

One feature of the present teaching is that the transmit and receive front end 1002 and subtractor 1040 has a broad bandwidth, such that any or all of the frequency bands of a particular cellular system, such as an FDD-based cellular system, can be appropriately passed amongst the first port 1004, second port 1016, and the third port 1020 as described. Therefore, the second port 1016 can pass transmit signals on one or more of multiple frequency bands for cellular transmit signal bands to the first port 1004 while the third port 1020 can pass receive signals from first port 1004 on one or more of multiple frequency bands for cellular receive signal bands. The one or more frequency bands for transmit and receive can be spectrally disjoint, and/or can have overlapping spectra.

In one method of operation, the transmit signal and the receive signal occupy the same cellular frequency band at the same time. In another method of operation, the transmit signal and the receive signal occupy different cellular frequency bands at the same time. For example, the transmit signal may be a cellular uplink channel for an FDD system, while the receive signal can be a cellular downlink channel for an FDD system, or vice versa. In the case where the transmit signal and the receive signal occupy disjoint cellular frequency bands, the signal separation occurs without the use of a filter, or a filtering frequency duplexer, that separates transmit and receive signals. This reduces component count and size of the transmit and receive front end 1002 as compared to known front ends that rely on filtering or filtering frequency duplexers. In some embodiments, the front end 1002 is used as the primary antenna front end 556, 638 for the RF system described in connection with FIGS. 5-6.

FIG. 11 illustrates another embodiment of an antenna system 1100 comprising a frequency-agnostic receive front end 1102 that utilizes a subtractor according to the present teaching. The first port 1104 connects to a diversity antenna 1106. The diversity antenna 1106 does not transmit. The diversity antenna 1106 receives both a desired receive signal 1108 and undesired, interference signals 1110. For example, the diversity antenna can be a cellular system diversity antenna. The connection to the diversity antenna 1106 can pass through an antenna matching circuit 1112. The front end 1102 has a first port 1104 for connecting to the antenna 1106, a second port 1114 for inputting a transmit reference signal 1116, and a third port 1118 for providing a receive signal 1120. The front end 1102 provides a receive signal and externally-generated interference signal(s) 1120 at the third port 1118 with substantially reduced undesired internal interference signal 1110 content.

A transmit reference signal 1116 is provided to the second port 1114. A portion of the transmit reference signal 1116 is provided to a transmit signal adjuster 1122 and to a signal processor 1124. The first port 1104 connects the antenna 1106 to an input port of a subtractor 1126. An output of the subtractor 1126 provides a receive signal to the third port 1118. A portion of the output receive signal from the subtractor 1126 is provided to the signal processor 1124. The signal processor 1124 provides an output to the transmit signal adjuster 1122 based on the input from the output of subtractor 1126 and the input transmit reference signal 1116. The output of the transmit signal adjuster 1122 is connected to a second input of the subtractor 1126.

In operation, the subtractor 1126 removes the internal interfering transmit signal(s) of undesired receive signals 1110 from the desired receive signal 1108 by using the signal-processed and adjusted transmit signal that is derived from processing the input transmit reference signal from the second port 1116. The signal processor 1124 determines the precise complex value of the transmit reference signal that should be fed to the second input of the subtractor 1026 so as to minimize the residual internal interfering transmit signal that is present in the receive path. The transmit signal adjustor 1122 is used to set the complex value of the transmit reference signal that is fed to the subtractor 1126.

Thus, after subtraction, only the receive signal and the externally-generated interference signal(s) are substantially present at the third port 1118, with internal interfering signals removed. This is true regardless of whether the frequency bands of the internal interfering transmit and receive signals are in the same or disjoint parts of the spectrum. The removal of the internal interfering signals occurs without the need for any filtering or frequency duplexer between the first port 1104 and the second ports 1114 and/or the third port 1118.

One feature of the frequency-agnostic wireless radio-frequency front end of the present teaching is that the receive front end 1102 and subtractor 1126 have a broad bandwidth, such that any or all of the frequency bands of a particular cellular system, such as an FDD-based cellular system, can be appropriately passed amongst the first port 1104, the second port 1114 and the third port 1118 as described. Therefore, the second port 1114 can pass transmit reference signals 1116 on one or more of multiple frequency bands used for cellular transmit signal bands to the signal processor 1124 and transmit signal adjuster 1122 while the third port 1118 can pass receive signals and the externally-generated interfering signal(s) from the first port 1104 on one or more of multiple frequency bands used for cellular receive signal bands.

The one or more frequency bands for transmit and receive can be spectrally disjoint, and/or can have overlapping spectra. In some embodiments, the transmit signal and the receive signal occupy the same cellular frequency band at the same time. In other embodiments, the transmit signal and the receive signal occupy different cellular frequency bands at the same time. For example, the transmit signal may be a cellular uplink channel for an FDD system while the receive signal is a cellular downlink channel for an FDD system, or vice versa. In the case where the transmit signal and the receive signal occupy disjoint cellular frequency bands, the signal separation occurs without the use of a filter or a filtering frequency duplexer to separate transmit and receive. This reduces component count and size of the receive front end 1102 as compared to known front ends that rely on filters or filtering frequency duplexers. In some embodiments, the receive front end 1102 is used as a diversity antenna receive front end 554, 634 for the system described in connection with FIGS. 5-6.

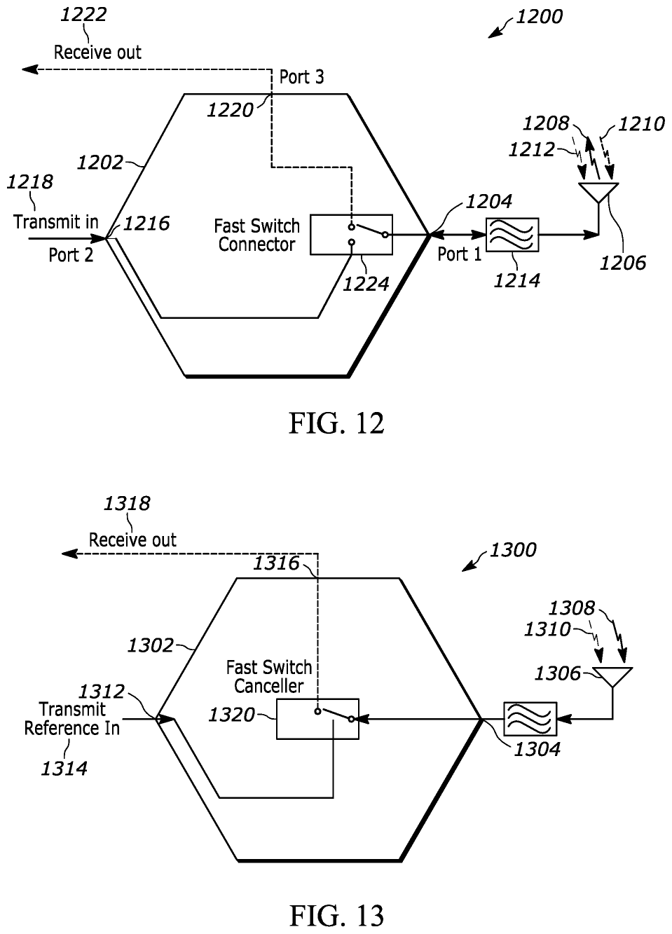

Another feature of the frequency-agnostic wireless radio-frequency front end of present teaching is that a fast switch can be used in a front end for a diversity antenna to pass one or more of multiple frequency bands in a cellular system. FIG. 12 illustrates an embodiment of an antenna system 1200 with a frequency-agnostic transmit and receive front end 1202 that utilizes a fast switch according to the present teaching. The first port 1204 connects to a primary antenna 1206 that radiates a transmit signal 1208. The primary antenna 1208 also collects a desired receive signal 1210 and undesired, externally-generated interference signals 1212. In some embodiments, the primary antenna 1206 is a cellular system primary antenna. The bidirectional connection from the first port 1204 to the antenna 1206 may pass through an antenna matching circuit 1214.

The transmit and receive front end 1202 has a first port 1204 for connecting to the antenna 1206, a second port 1216 for inputting a transmit signal 1218, and a third port 1220 for providing a receive signal 1222. Thus, the front end 1202 connects three signal paths, a bidirectional signal path from and to the antenna 1206, a transmit signal path, and a receive signal path via the first port 1204, second port 1216, and the third port 1220. The first port 1204 connects to a common port of a single-pole double-throw switch 1224. The switched ports of the switch 1224 connect to the second port 1216 and to the third port 1220. The switch 1224 samples the receive signal by connecting the first port 1204 to the third port 1220 for a short sampling time, and connects the first port 1204 to the second port 1216 for the remainder of a period between samples. In some embodiments, the sampling time is from 1-10% of the period and the sampling time is synchronized to occur when the transmit signal passes through zero. In one specific embodiment, the period is a Nyquist sampling period. See, for example, U.S. Pat. No. 9,209,840, entitled “Same-Aperture Any-Frequency Simultaneous Transmit and Receive Communication System”, which is assigned to the present assignee and which is incorporated herein by reference.

Yet another feature of the present teaching is that the transmit and receive front end 1202 and fast switch 1224 can operate with a broad bandwidth, such that any or all of the frequency bands of a particular cellular system, such as an FDD-based cellular system, can be appropriately passed amongst the first port 1204, second port 1216, and the third port 1220 as described. Switch devices that operate at the Nyquist rate of typical receive signals in a cellular system and a sample interval that is less than 10% of that sample period are available. Therefore, the second port 1216 can pass transmit signals 1218 on one or more of multiple frequency bands for cellular transmit signal bands to the first port 1204 while the third port 1220 can pass receive signals from the first port 1204 on one or more of multiple frequency bands for cellular receive signal bands.

The one or more frequency bands for transmit and receive can be spectrally disjoint, and/or can have overlapping spectra. In some embodiments, the transmit signal and the receive signal occupy the same cellular frequency band at the same time. In other embodiments, the transmit signal and the receive signal occupy different cellular frequency bands at the same time. For example, the transmit signals can be a cellular uplink channel for an FDD system while the receive signal can be a cellular downlink channel for an FDD system, or vice versa. In the case where the transmit signal and the receive signal occupy disjoint cellular frequency bands, the signal separation occurs without the use of a filter or a filtering frequency duplexer to separate transmit and receive. This reduces component count and size of the front end 1202 as compared to known front ends that rely on filtering or filtering frequency duplexers. In some embodiments, the transmit and receive front end 1202 is used as the primary antenna transmit and receive front end 556, 638 for the system described in connection with FIGS. 5-6.

FIG. 13 illustrates an embodiment of an antenna system 1300 with a frequency-agnostic receive front end 1302 that utilizes a fast switch according to the present teaching. The first port 1304 connects to a diversity antenna 1306 that collects a desired receive signal 1308 and undesired, externally-generated interference signals 1310. In some embodiments, the diversity antenna 1306 is a cellular system diversity antenna.

The receive front end 1302 has a first port 1304 for connecting to the antenna 1306, a second port 1312 for inputting a transmit reference 1314, and a third port 1316 for providing a receive signal 1318. The first port 1304 connects to a common port of a single-pole single-throw switch 1320. The switched port of the switch 1320 connects to the second port 1312 and the switch control connects to the third port 1316. The switch 1320 samples the receive signal by connecting the first port 1304 to the third port 1316 for a short sampling time. The sampling time is from 1-10% of the period and the sampling time is synchronized to occur when the transmit signal passes through zero. In some embodiments the sampling time is synchronized to at least some of the transmit signal zero crossings.

### EQUIVALENTS

While the Applicant's teaching is described in conjunction with various embodiments, it is not intended that the Applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

1. A frequency agnostic wireless RF front end comprising:
a) a receive front end having a first port configured to receive signals comprising an internal interference signal, an external interference signal and a desired receive signal and having a second port that is configured to be electrically connected to a transmit signal reference source, the receive front end comprising a cancelling circuit that at least partially removes the internal interference signal and the external interference signal from the signals received by the first port and provides the desired receive signal to a third port; and
b) a transmit-and-receive front end having a first port configured to receive signals comprising the desired receive signal and interference signals, and configured to transmit signals comprising a desired transmit signal and having a second port that is configured to be electrically connected to a transmitter that generates the desired transmit signal, the transmit-and-receive front end comprising a connector that passes the desired transmit signal propagating from the second port to the first port while simultaneously passing the desired receive signal and interference signals to a third port while at least partially blocking the desired transmit signal from propagating to the third port.

2. The frequency agnostic wireless RF front end of claim 1, wherein the receive front end is configured to pass FDD LTE frequency bands.

3. The frequency agnostic wireless RF front end of claim 1, wherein the receive front end is configured to pass cellular telephony frequency bands.

4. The frequency agnostic wireless RF front end of claim 1, wherein the receive front end is configured to pass all cellular telephony frequency bands.

5. The frequency agnostic wireless RF front end of claim 1, wherein the transmit-and-receive front end is configured to pass FDD LTE frequency bands.

6. The frequency agnostic wireless RF front end of claim 1, wherein the transmit-and-receive front end is configured to pass cellular telephony frequency bands.

7. The frequency agnostic wireless RF front end of claim 1, wherein the transmit-and-receive front end is configured to pass all cellular telephony frequency bands.

8. The frequency agnostic wireless RF front end of claim 1, wherein the transmit-and-receive front end comprises an isolating power amplifier that passes the desired transmit signal propagating from the second port to the first port.

9. The frequency agnostic wireless RF front end of claim 8, wherein the isolating power amplifier comprises a voltage source isolator.

10. The frequency agnostic wireless RF front end of claim 1, wherein the canceller comprises a canceller processor.

11. The frequency agnostic wireless RF front end of claim 1, wherein the transmit-and-receive front end comprises a connector that connects the first port to an input of an electronic differencing device.

12. The frequency agnostic wireless RF front end of claim 1, wherein the transmit-and-receive front end comprises a non-reciprocal waveguide device that at least partially blocks the desired transmit signal from propagating to the third port.

13. The frequency agnostic wireless RF front end of claim 1 further comprising an interference reducer processor having an input electrically connected to the third port of the transmit-and-receive front end, and an output configured to be electrically connected to a receiver, the interference reducer processor separating the interference signals from the desired receive signal and directing the desired receive signal to the receiver.

14. The frequency agnostic wireless RF front end of claim 13 wherein the interference reducer processor comprises a basis function generator.

15. The frequency agnostic wireless RF front end of claim 14 wherein the basis function generator is configured to generate amplitudes and phases of a carrier and a subcarrier of a cellular signal.

16. The frequency agnostic wireless RF front end of claim 14 wherein the basis function generator is configured to generate amplitudes and phases of a carrier and a subcarrier of a FDD LTE cellular signal.

17. The frequency agnostic wireless RF front end of claim 1 further comprising a first antenna electrically connected to the first port of the transmit-and-receive front end that receives the desired receive signal and interference signals and that transmits the desired transmit signal.

18. The frequency agnostic wireless RF front end of claim 17 further comprising a second antenna electrically connected to the first port of the receive front end that receives the internal interference signal, the external interference signal, and the desired receive signal.

19. The frequency agnostic wireless RF front end of claim 18, wherein the second antenna is positioned proximate to the first antenna so that it receives the internal interference signal via coupling an electromagnetic signal from the first antenna.

20. The frequency agnostic wireless RF front end of claim 18, wherein the second antenna is positioned so that it receives the interference signal from a ferrite circulator positioned within the frequency agnostic wireless RF front end.

21. The frequency agnostic wireless RF front end of claim 18 further comprising an antenna matching circuit that couples the receive front end to the second antenna.

22. The frequency agnostic wireless RF front end of claim 17 further comprising an antenna matching circuit that couples the transmit-and-receive front end to the first antenna.

23. The frequency agnostic wireless RF front end of claim 1 wherein the transmit signal reference source is configured to generate a reference copy of the internal interference signal.

24. The frequency agnostic wireless RF front end of claim 1 wherein the transmit signal reference source is configured to generate a reference copy of the external interference signal.

25. The frequency agnostic wireless RF front end of claim 1 further comprising a transceiver having an input that is connected to the third port of the receive front end and an input that is connected to the third port of the transmit-and-receive front end.

26. A frequency-agnostic method of suppressing signals, the method comprising:
a) receiving signals comprising an internal interference signal, an external interference signal, and a desired receive signal at a front end;
b) partially removing the internal interference signal and the external interference signal from the received signals using a transmit reference signal, thereby providing the desired receive signal at a first output;
c) receiving signals comprising the desired receive signal, interference signals and transmitting signals comprising a desired transmit signal at a port of a second front end; and
d) passing the desired transmit signal to the port at the second front end while simultaneously passing the desired receive signal and interference signals from the port at the second front end to a second output while at least partially blocking the desired transmit signal from propagating to the second output.

27. The frequency-agnostic method of suppressing signals of claim 26 wherein the receiving signals comprise the internal interference signal and the external interference signal, and the desired receive signal comprises receiving signals at FDD LTE frequency bands.

28. The frequency-agnostic method of suppressing signals of claim 26 wherein the receiving signals comprise the internal interference signal, the external interference signal and the desired receive signal comprises receiving signals at cellular telephony frequency bands.

29. The frequency-agnostic method of suppressing signals of claim 26 wherein the receiving signals comprise the internal interference signal and the external interference signal, and the desired receive signal comprises receiving signals at a plurality of cellular telephony frequency bands.

30. The frequency-agnostic method of suppressing signals of claim 26 wherein the passing the desired transmit signal to the port at the second front end while simultaneously passing the desired receive signal and interference signals from the port at the second front end to the second output while at least partially blocking the desired transmit signal from propagating to the second output comprises passing signals at FDD LTE frequency bands.

31. The frequency-agnostic method of suppressing signals of claim 26 wherein the passing the desired transmit signal to the port at the second front end while simultaneously passing the desired receive signal and interference signals from the port at the second front end to the second output while at least partially blocking the desired transmit signal from propagating to the second output comprises passing signals at cellular telephony frequency bands.

32. The frequency-agnostic method of suppressing signals of claim 26 wherein the passing the desired transmit signal to the port while simultaneously passing the desired receive signal and interference signals from the port to the second output while at least partially blocking the desired transmit signal from propagating to the second output comprises passing signals at a plurality of cellular telephony frequency bands.
